(19) United States
(12) Patent Application Publication
(10) Pub. No.: US 2026/0251856 A1
(43) Pub. Date: Aug. 27, 2026

(54) HIGH SKEW PUMP COMBINER

(71) Applicant: Lumentum Operations LLC, San Jose, CA (US)

(72) Inventors: Richard D. FAULHABER, San Carlos, CA (US); Martin H. MUENDEL, Oakland, CA (US); Jeff GREGG, San Jose, CA (US); Matthew KUTSURIS, Dublin, CA (US); Ning LIU, Morgan Hill, CA (US)

(21) Appl. No.: 19/096,171

(22) Filed: Mar. 31, 2025

Related U.S. Application Data
(60) Provisional application No. 63/762,723, filed on Feb. 25, 2025.

(51) Int. Cl. G02B 6/42

(52) U.S. Cl. CPC G02B 6/4203

(57) ABSTRACT

In some implementations, a pump combiner may comprise a central capillary and a plurality of pump fibers surrounding the central capillary, wherein the plurality of pump fibers are twisted around the central capillary and tapered toward an output from the pump combiner. In some implementations, an optical assembly may comprise the pump combiner, a laser source configured to generate signal light, a plurality of diodes configured to generate pump light, and an optical fiber that comprises a core and a cladding. An input end of the pump combiner may be coupled to the plurality of diodes, and the optical fiber may be coupled to the laser source and to an output end of the pump combiner such that the signal light is delivered to a core of the optical fiber and the pump light is delivered only to a cladding of the optical fiber.

### CROSS-REFERENCE TO RELATED APPLICATION

This patent application claims priority to U.S. Provisional Patent Application No. 63/762,723, filed on Feb. 25, 2025, and entitled “HIGH SKEW PUMP COMBINER WITH DEPLETED CENTER.” The disclosure of the prior application is considered part of and is incorporated by reference into this patent application.

### TECHNICAL FIELD

The present disclosure relates generally to a pump combiner and to a structure and method for fabricating a pump combiner that outputs a high proportion of skew light.

### BACKGROUND

Pump combiners are components that are often used in high-power fiber lasers. Pump combiners are used to combine pump light from several laser diodes and to deliver the combined pump light to a single fiber where the pump light combines with signal light to increase a power of the signal light. For example, techniques to optically pump a medium generally include injecting light into the medium in order to electronically excite the medium or constituents of the medium into other (usually higher-order) energy levels. In the context of lasers or laser amplifiers, the goal of optical pumping is to achieve a population inversion in the medium where gain is desired, and thereby obtain optical amplification via stimulated emission for a range of optical frequencies. In many cases, pump combiners are arranged in a bundle configuration, which is spliced to another optical structure (e.g., a master oscillator power amplifier (MOPA) or a single pass fiber laser structure) that is configured to deliver many hundreds of watts (W) or kilowatts (kW) of pump power. A bundle configuration can be achieved by arranging several pump fibers into a particular close-packed configuration (e.g., a hexagonal close-packing configuration) and then fusing and tapering the pump fibers into a bundle with a target size.

### SUMMARY

In some implementations, a pump combiner includes a central capillary; and a plurality of pump fibers surrounding the central capillary, wherein the plurality of pump fibers are twisted around the central capillary and tapered toward an output from the pump combiner.

In some implementations, a method for fabricating a high skew pump combiner includes loading a bundle that comprises a capillary and a plurality of pump fibers surrounding the capillary into one or more chucks; tapering the bundle while rotating the one or more chucks, wherein tapering the bundle causes the bundle to have a diameter that gradually decreases from a first end toward a second end, and wherein rotating the one or more chucks while tapering the bundle causes the plurality of pump fibers to be twisted around the capillary; and cleaving the tapered bundle at a waist to form the high skew pump combiner.

In some implementations, an optical assembly includes a laser source configured to generate signal light; a plurality of diodes configured to generate pump light; a pump combiner that comprises a central capillary and a plurality of pump fibers surrounding the central capillary, wherein the plurality of pump fibers are coupled to the plurality of diodes at an input end of the pump combiner, and wherein the plurality of pump fibers are twisted around the central capillary and tapered toward an output end of the pump combiner; and an optical fiber coupled to the laser source and to the output end of the pump combiner such that the signal light is delivered to a core of the optical fiber and the pump light is delivered only to a cladding of the optical fiber.

### BRIEF DESCRIPTION OF THE DRAWINGS

FIG. 1 illustrates an example laser architecture that may include a pump combiner.

FIG. 2 illustrates an example process for fabricating a high skew pump combiner.

FIG. 3 illustrates examples associated with a high skew pump combiner.

FIG. 4 illustrates performance metrics in a laser architecture with a high skew combiner relative to performance metrics in a laser architecture with a low skew combiner.

FIG. 5 illustrates an example process for fabricating a high skew pump combiner.

### DETAILED DESCRIPTION

The following detailed description of example implementations refers to the accompanying drawings. The same reference numbers in different drawings may identify the same or similar elements.

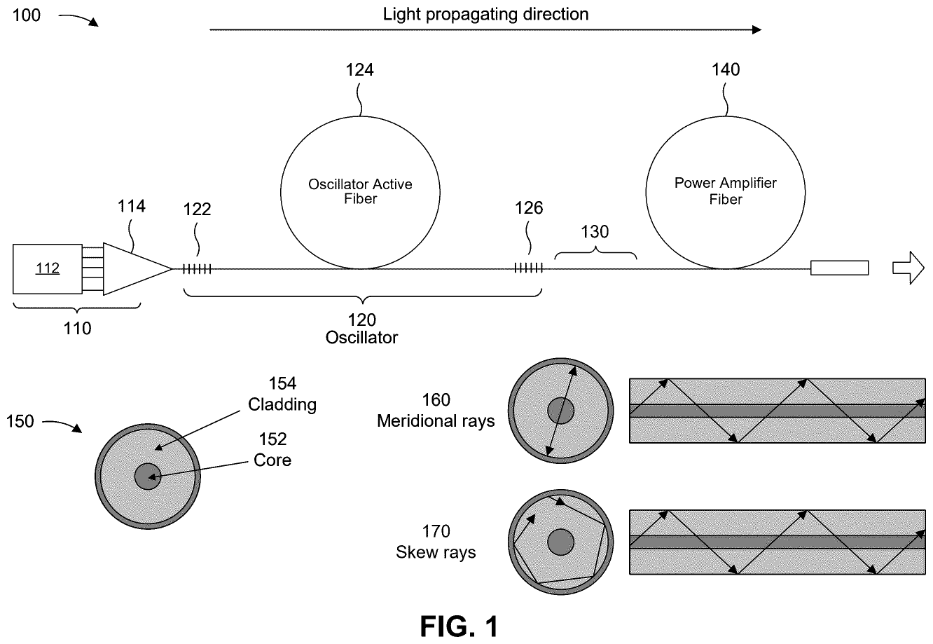

FIG. 1 illustrates an example laser architecture 100 that may include a pump combiner. In particular, the laser architecture 100 shown in FIG. 1 is an example master oscillator power amplifier (MOPA) laser architecture in which a pump source 110 generates pump light that can be combined with signal light to increase or scale the signal light to a higher power.

For example, as described herein, laser power scaling generally includes techniques to increase an output power from a laser without changing the geometry, shape, or principle of operation of the laser. Power scalability, which is considered an important advantage in laser design, usually requires a more powerful pump source, stronger cooling, an increase in size, and/or a reduction in background loss in a laser resonator and/or a gain medium. For example, one approach to achieving power scalability in a laser architecture is to use a MOPA architecture, such as the MOPA laser architecture shown in FIG. 1, where a fiber-based master oscillator 120 produces a highly coherent beam, and an optical power amplifier 140 increases the power of the beam while preserving the main properties of the beam. For example, the master oscillator 120 may be a low-power, single-frequency laser oscillator, and an output from the master oscillator 120 may be injected unidirectionally into the optical power amplifier 140, which has a greater output power capacity than the master oscillator 120. In some cases (e.g., as shown in FIG. 1), the power amplifier 140 may be a fiber device, such that the laser architecture 100 with the fiber-based power amplifier 140 is a master oscillator fiber amplifier (MOFA). In some other cases, a MOPA architecture may include a solid-state bulk laser and a bulk amplifier, or a tunable external cavity diode laser and a semiconductor optical amplifier.

Referring to FIG. 1, the laser architecture 100 includes a multi-kilowatt (kW) pump source 110 comprising a set of laser diodes 112, a pump combiner 114, and a set of output fibers coupling the set of laser diodes 112 and the pump combiner 114. As further shown and described herein, the laser architecture 100 includes the master oscillator 120 to produce a highly coherent beam. For example, the master oscillator 120 may comprise a first reflector 122 (e.g., a first fiber Bragg grating (FBG)), an active fiber 124, and a second reflector 126 (e.g., a second FBG). The first reflector 122 may be used as a high reflector (HR) to reflect a high percentage of light emitted from the active fiber 124 between the pump combiner 114 and an input end of the active fiber 124, and the second reflector 126 may be used as an output coupler at an output end of the active fiber 124. The laser architecture 100 may include the power amplifier 140, and a passive fiber 130 that couples the output end of the master oscillator 120 to the power amplifier 140 (e.g., via the second reflector 126 configured as the output coupler at the output end of the active fiber 124). In some examples, the laser architecture 100 may include other components in the optical chain (e.g., filters for undesired wavelengths or unabsorbed pump light).

As described herein, the pump combiner 114 may be coupled to the diodes 112 that generate pump light. In some cases, the pump light generated by the diodes 112 may have a relatively low brightness. Accordingly, the pump combiner 114 may combine the pump light generated by the low-brightness diodes 112 and deliver the combined pump light to a single optical fiber (e.g., the active fiber 124) where the pump light can be converted to a high-brightness laser output. For example, in a laser architecture 100 with N laser diodes 112 configured to generate low-brightness pump light, the pump combiner 114 may be an N:1 pump combiner with N pump fibers that are configured to combine and couple the pump light from the N laser diodes into a single optical fiber where the pump light can combine with signal light to increase the power of the signal light. In this way, a fiber laser such as the MOPA laser architecture shown in FIG. 1 is essentially a brightness converter (e.g., converting low-brightness pump light from several sources into a high-brightness laser output). In general, one goal in designing a pump combiner is to conserve the brightness and power of the diodes 112 as much as possible as the pump light is combined and coupled into to the laser fiber for conversion.

After the pump light is combined in the pump combiner 114 and delivered to the laser fiber spliced to an output from the pump combiner 114, the pump light is typically distributed uniformly over a core and a cladding of the laser fiber. For example, FIG. 1 depicts a cross-section of an optical fiber 150 that may be spliced to the output from the pump combiner 114, where the optical fiber 150 includes a core 152 and a cladding 154. The core 152 may be coupled to a signal fiber or a laser source (not shown in FIG. 1) configured to generate signal light (e.g., light at a desired wavelength to carry a signal, such as 1080 nanometers or another suitable wavelength), and the output from the pump combiner 114 may be spliced to the optical fiber 150 to deliver the combined pump light (e.g., at another wavelength, such as 976 nanometers) into the optical fiber 150 where the pump light combines with the signal light to increase the overall power of the signal light. In cases where the pump light provided to the optical fiber 150 is uniformly distributed over the core 152 and the cladding 154 at an interface between the pump combiner 114 and the optical fiber 150, the proportion of the pump light delivered to the core 152 is

$${Pump}_{total} \times \frac{{A}_{c o r e}}{{A}_{c l a d}} ,$$

where Pumpₜₒₜₐₗ is the combined pump light carried in the core 152 and the cladding 154, A_{core} is the cross-sectional area of the core 152, and A_{clad} is the cross-sectional area of the cladding 154.

In the scenario described above, where the pump light delivered from the pump combiner 114 to the optical fiber 150 is uniformly distributed over the core 152 and the cladding 154, the pump light delivered to the core 152 is absorbed and converted to signal light. For example, as shown in FIG. 1, the pump light delivered from the pump combiner 114 to the optical fiber 150 may include meridional rays 160 that pass through an axis of the optical fiber 150, and therefore pass through the core 152 of the optical fiber 150, and/or skew rays 170 that travel through 150 optical fiber without passing through the axis or the core 152. In particular, as shown, the skew rays 170 circulate only in the cladding 154 surrounding the core 152. In a round, uniform fiber, skew rays 170 remain skew and are essentially never absorbed in the core 152. In other words, as soon as the small portion of pump light overlapping the core 152 (meridional rays 160) is absorbed, the remaining pump light (skew rays 170) orbit the core 152 and have a very low absorption. Accordingly, one technique to maximize absorption of the pump light in the core 152 is to fabricate the pump combiner 114 in a manner that reduces the amount of skew rays 170 that are output by the pump combiner 114. For example, the pump combiner 114 may be fabricated by twisting bundled pump fibers to achieve a close packing, and then applying a heat source to taper the twisted bundle down to a desired diameter to reduce the amount of skew rays 170 (e.g., because tapering the bundle has a net effect of distributing an original twist rate over a much longer distance, which in turn reduces the amount of skew rays 170). Other techniques to increase absorption of the pump light include scrambling any skew rays 170 output by the pump combiner 114 as much as possible and as close as possible to the interface with the optical fiber 150. For example, the skew rays 170 may be scrambled by shaping the optical fiber 150 such that the cladding 154 has a non-round shape (e.g., hexagonal or octagonal) to reduce a split between meridional rays 160 and skew rays 170, causing all modes to have substantial overlap in the core 152 and relatively uniform absorption.

However, structuring the pump combiner 114 to generate no skew rays 170 or minimal skew rays 170 and/or scrambling the skew rays 170 as much as possible and as close as possible to the interface with the optical fiber 150 poses challenges in some cases. For example, when there are minimal or no skew rays 170 or the skew rays 170 are scrambled to increase absorption, the signal light may experience a sharp power increase in a region of the optical fiber 150 near the interface with the pump combiner 114, which may lead to instability, an increased heat load, or other deleterious or undesirable effects. Additionally, or alternatively, there may be some applications where confining pump light to the cladding 154 surrounding the core 152 is desired (e.g., to manage or mitigate optical distortions or aberrations, or to ensure that light travels along different paths to avoid interference, diffraction, or crosstalk in a waveguide). Accordingly, in some implementations, as described in further detail herein, the pump combiner 114 may be fabricated to output pump light that is uniformly (100 percent) skew or highly skew (e.g., at least ninety percent) at the interface with the optical fiber 150, such that the pump combiner 114 is a “high skew” pump combiner 114. In some implementations, the skew rays 170 output by the high skew pump combiner 114 may be confined to the cladding 154 around the core 152 (e.g., in an optical system or application where skew light is desired). Alternatively, in some implementations, the skew rays output by the high skew pump combiner 114 may be scrambled over a longer length of the optical fiber 150 (e.g., at least one meter), such that the power of the signal light increases gradually over the length of the optical fiber 150 and a heat load in a region near the interface between the optical fiber 150 and the pump combiner 114 is reduced.

As indicated above, FIG. 1 is provided as an example. Other examples may differ from what is described with regard to FIG. 1. For example, the number, arrangement, and configuration of devices shown in FIG. 1 are provided as an example, and the pump combiner may be used in laser architectures or optical assemblies with additional devices or components, fewer devices or components, different devices or components, or differently arranged devices or components than shown in FIG. 1. Additionally, or alternatively, one or more components or one or more devices of the laser architecture 100 may perform one or more functions described as being performed by another set of components or devices of the laser architecture 100.

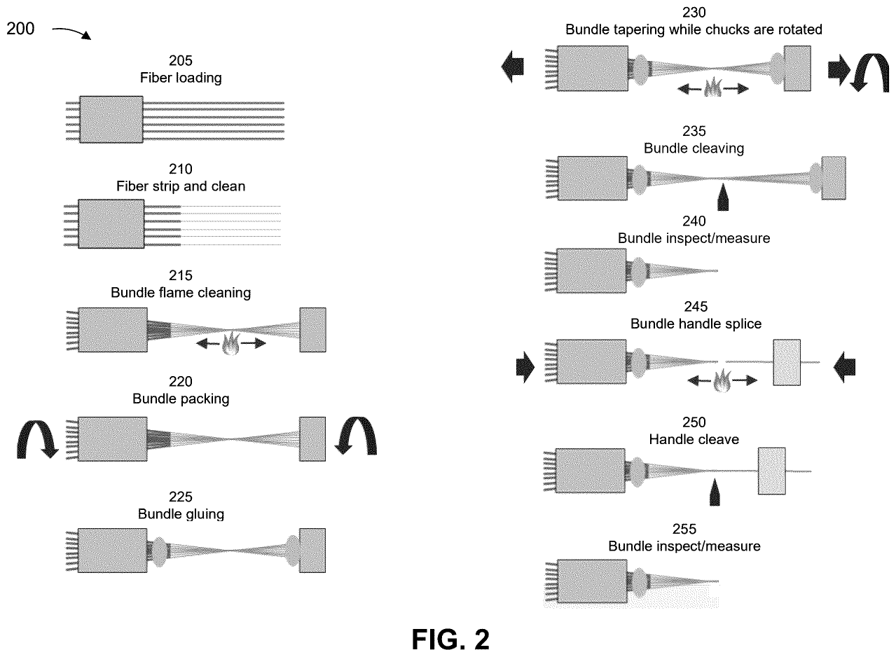

FIG. 2 illustrates an example process 200 for fabricating a high skew pump combiner. For example, as described herein, a high skew pump combiner may output pump light that is uniformly skew, or highly skew relative to non-skew pump light (e.g., pump light distributed directly to a core of an optical fiber and/or non-meridional light that is readily absorbed in the core). For example, as described herein, the high skew pump combiner can be fabricated by applying an initial twist to a fiber bundle to achieve a close packing, and then applying a heat source to taper the twisted bundle down to a desired final diameter. Furthermore, to increase the proportion of skew pump light versus non-skew pump that is output by the pump combiner, additional rotation(s) may be applied to the bundle during the tapering process in order to increase or at least maintain the twist in the bundled fibers to generate much more skew light.

Accordingly, in some implementations, example process 200 may be performed to fabricate a high-skew combiner, which may be used in conjunction with a variable scrambler or other suitable components in a laser, or used to confine pump light to a cladding region in an output fiber, among other examples. For example, in a first step 205, a bundle that includes a central capillary (e.g., along a central axis of the pump combiner) and a plurality of pump fibers surrounding the central capillary may be loaded into a first chuck. For example, the central capillary may provided to maintain an air gap along the central axis of the pump combiner. Alternatively, other suitable structures may be used to provide the air gap, or the bundle may be formed with an empty space in the center. In some implementations, the bundle may also include an outer capillary, where the pump fibers and the central capillary are nested within the outer capillary. In a second step 210, the pump fibers may be stripped and cleaned (e.g., to remove an outer coating or enclosure from the pump fibers and to clean the exposed areas of the fibers). In some implementations, the first step 205 and the second step 210 may be performed using equipment at an acid stripping station or using other suitable manufacturing equipment, and the remaining steps in the process 200 may be performed using equipment at a flame station or using other suitable manufacturing equipment.

As further shown in FIG. 2, in a third step 215, an opposite end of the bundle may be loaded into a second chuck and a flame may be applied to clean the bundle through heating. For example, the heat source may be movable along a region of the bundle between the two chucks, which cleans any contamination or residue from the exposed regions of the pump fibers or the outer capillary (if present). In some implementations, in a fourth step 220, the bundle may be packed into a close packing configuration. For example, packing the bundle into a close packing configuration may include applying an initial twist to the bundle, such that the pump fibers are twisted around the central capillary to achieve a desired close packing configuration (e.g., minimizing spaces between adjacent pump fibers and/or minimizing spaces between the pump fibers and the central capillary). For example, when the heat source moves along the region of the bundle that is cleaned in the third step 215, the heated region becomes soft and malleable. The bundle can then be twisted by rotating the chucks at both ends of the bundle to achieve the desired close packing configuration. Alternatively, in examples where the bundle includes an outer capillary, the fourth step 220 may be omitted (e.g., because the outer capillary secures the nested pump fibers in the desired close packing configuration). In a fifth step 225, the bundle may be glued together at regions near the two chucks to securely hold the bundle.

As further shown in FIG. 2, in a sixth step 230, the bundle may be tapered down to a desired diameter. For example, in some implementations, the bundle may be tapered by again moving the flame or heat source back and forth over a region of the bundle such that the heated region becomes soft and pliable. Alternatively, the heat source may remain stationary and the bundle may be moved back over the heat source to make the desired region soft and pliable. The bundle is then stretched by moving the two chucks in opposite directions (away from each other) such that the heated (softened) region narrows in diameter. Furthermore, as shown in FIG. 2, one or more of the chucks are additionally rotated in the sixth step 230, to increase or at least maintain any initial twist that was applied in the fourth step 220, or to otherwise ensure that the pump fibers in the bundle are twisted around the central capillary to a desired degree over a desired length in the final pump combiner structure. Accordingly, in the sixth step 230, the pump fibers may be twisted tightly around the central capillary, and fused together through the tapering process, such that the pump fibers are twisted with an approximately 360 degrees rotation over a length of a few millimeters (e.g., three to ten millimeters), with the tapered bundle having a total length in a range from about 20-30 millimeters and a taper ratio in a range from about 2:1 to about 5:1. In a seventh step 235, the bundle may be cleaved at a waist (e.g., at a location where the tapered bundle has a minimum diameter).

As further shown in FIG. 2, the bundle may then be inspected and measured in an eighth step 240 to ensure that the pump fibers satisfy the desired taper ratio and twist rotation. In some implementations, if the bundle passes the inspection in the eighth step 240, a handle of the bundle (e.g., the tapered end of the bundle) may be spliced to a target fiber in a ninth step 245 (e.g., while applying heat to the splicing region and moving the chucks toward each other), and the handle may be cleaved in a tenth step 250. Alternatively, if the bundle fails the inspection in the eighth step 240, one or more steps may be repeated until the desired quality and measurements are achieved. After the bundle passes the inspection and the handle is cleaved, the bundle may be inspected and measured again in an eleventh step 255. If the bundle passes the inspection in the eleventh step 255, the bundle is usable as a high skew pump combiner in any suitable optical system or assembly, such as the MOPA architecture shown in FIG. 1. Alternatively, if the bundle fails the inspection in the eleventh step 255, one or more steps may be repeated until the bundle has the desired quality and the appropriate measurements to be usable as a high skew pump combiner.

As indicated above, FIG. 2 is provided as an example. Other examples may differ from what is described with regard to FIG. 2. For example, although FIG. 2 shows example steps in the process 200 for fabricating the high skew pump combiner, in some implementations, the process 200 may include additional steps, fewer steps, different steps, or steps that may be performed in a different order than the steps depicted in FIG. 2. Additionally, or alternatively, two or more of the steps in process 200 may be performed in parallel or concurrently.

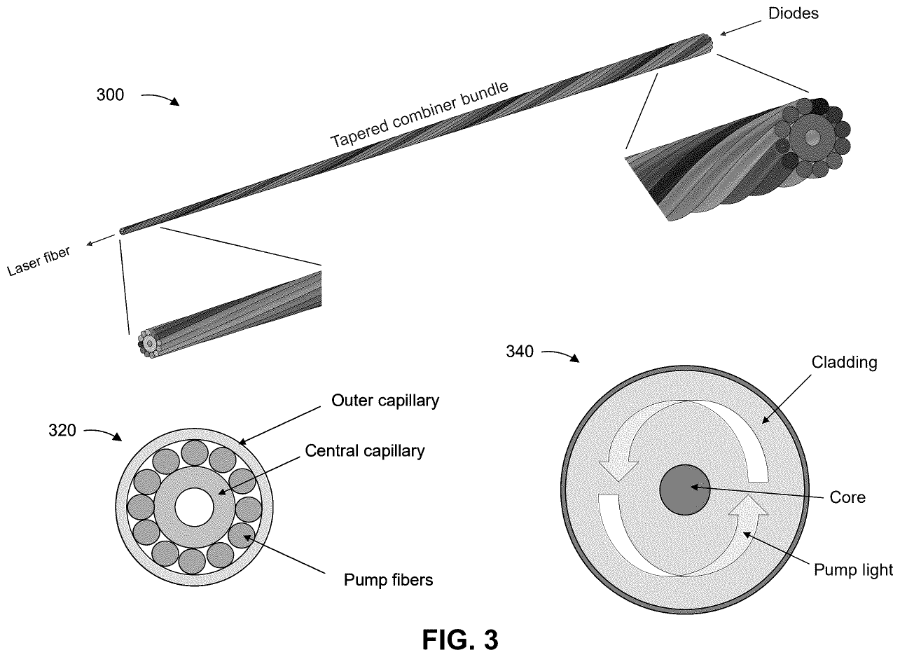

FIG. 3 illustrates examples associated with a high skew pump combiner. In particular, FIG. 3 illustrates an example high skew pump combiner 300 with a depleted center (e.g., a central capillary to provide an air gap at the center of the high skew pump combiner 300), an example high skew pump combiner 320 with a depleted center and an outer capillary, and a cross-section of an optical fiber 340 at or near a location where the optical fiber 340 is spliced to the high skew pump combiner 300 or the high skew pump combiner 320.

As shown in FIG. 3, the high skew pump combiner 300 includes multiple pump fibers that surround a central capillary in a tapered combiner bundle, where the multiple pump fibers are each coupled to a respective diode that generates pump light to be combined within the high skew pump combiner 300. During fabrication, the multiple pump fibers forming the high skew pump combiner 300 are initially twisted tightly around the central capillary or other suitable structure forming a depleted center, and then fused together and further twisted during a tapering process to maintain a twist of about 360 degrees rotation over a length of a few millimeters, with the high skew pump combiner 300 having a total length in a range from about 20-30 millimeters and a taper ratio in a range from about 2:1 to about 5:1 (e.g., where the diameter at the interface with the diodes is between two and five times the diameter at an interface with a laser fiber). In the example shown in FIG. 3, the high skew pump combiner 300 includes twelve pump fibers that are wrapped around the capillary, although more or fewer pump fibers may be used. In some cases, the high skew pump combiner 300 may include a passthrough signal fiber (e.g., to carry signal light) to function as a pump-signal combiner. Additionally, or alternatively, the signal fiber may be replaced with a secondary pump fiber for the confined region.

In some implementations, the high skew pump combiner 320 is generally similar to the high skew pump combiner 300, except that the high skew pump combiner 320 includes an outer capillary or enclosure. As shown in FIG. 3, the high skew pump combiner 320 includes a central capillary and multiple pump fibers (e.g., twelve in the illustrated example) that surround the central capillary, and the outer capillary surrounds the bundled pump fibers that are twisted around the central capillary (e.g., the bundled pump fibers are twisted around the central capillary during the tapering process, but not during the packing process, when the outer capillary is present). In some implementations, the outer capillary ensures that the bundled pump fibers are packed in a close configuration, whereby no initial twist may be needed. Instead, during the process to fuse and taper the high skew pump combiner 320, the chucks may be rotated at a faster spin rate relative to the high skew pump combiner 300 without an outer capillary or other enclosure to surround the bundled pump fibers.

Accordingly, an optical fiber 340 spliced to either the high skew pump combiner 300 or the high skew pump combiner 320 may function as a skew pump laser. In some implementations, pump light generated by the various diodes may be coupled into and combined within the high skew pump combiner 300 or the high skew pump combiner 320. In some implementations, after the pump light is combined within the high skew pump combiner 300 or the high skew pump combiner 320 and coupled into the optical (laser) fiber 340 at an output end (corresponding to an input end of the optical fiber 340), the pump light is uniformly skew such that all of the pump light is delivered to the cladding and none of the pump light is delivered to the core of the optical fiber 340. Furthermore, the pump light delivered to the cladding does not include any meridional rays. Alternatively, the pump light delivered to the optical fiber 340 may be mostly skew, such that at least ninety percent of the pump light delivered to the optical fiber 340 is distributed in the cladding as skew light, and no more than ten percent of the pump light delivered to the optical fiber 340 is distributed in the core or the cladding as meridional light.

In some implementations, the skew light in the cladding may be scrambled as the pump light propagates along the fiber 340, which allows the amount of pump light in the core to be effectively controlled, which in turn allows the heating in the core to be controlled. For example, there is initially zero pump light, negligible pump light, or a small amount of pump light in the core (e.g., less than ten percent), and the final pump light in the core (after scrambling, at the output of the fiber 340), is given by

$$\frac{{A}_{c o r e}}{{A}_{c l a d}} * {Pump}_{total} ,$$

as described above. Furthermore, power distributions within the laser fiber may be tailored to be linear or have other suitable properties. Alternatively, in some implementations, the skew light may be confined to the cladding and not scrambled (e.g., in an optical system or application where skew light is desired).

As indicated above, FIG. 3 is provided as an example. Other examples may differ from what is described with regard to FIG. 3. For example, the number, arrangement, and configuration of pump fibers, capillaries, and other devices (e.g., diodes and fiber laser) shown in FIG. 3 are provided as an example, and the high skew pump combiner 300 or the high skew pump combiner 320 may be used in optical assemblies with different numbers, arrangements, and/or configurations of pump fibers, capillaries, and/or other devices.

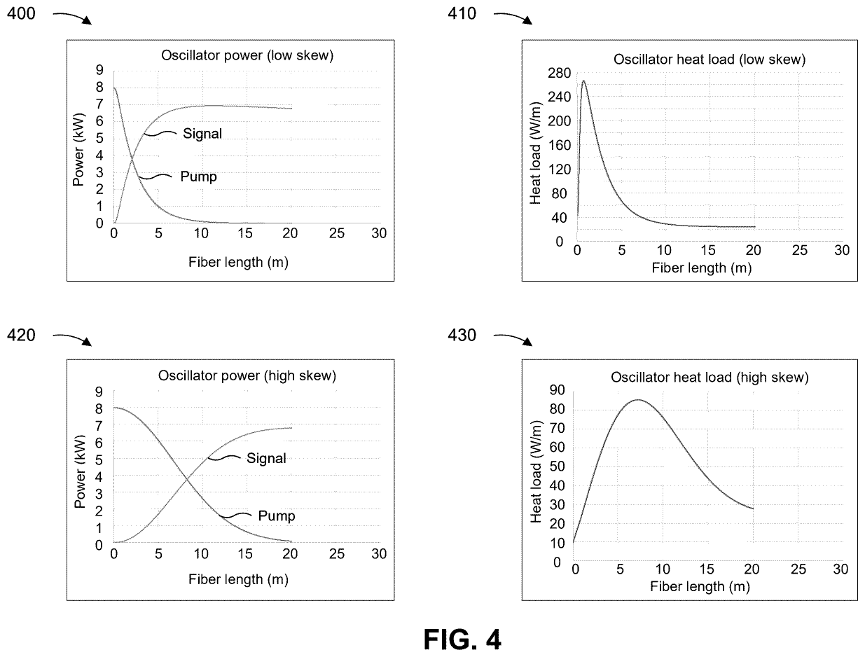

FIG. 4 illustrates performance metrics in a laser architecture with a high skew combiner relative to performance metrics in a laser architecture with a low skew combiner. In particular, FIG. 4 illustrates an example 400 of power through an oscillator coupled to a low skew pump combiner, or where skew light output by the pump combiner is scrambled as much as possible at the interface between the oscillator and the pump combiner (e.g., there is a low amount of skew light in the cladding of the oscillator fiber at the interface with the pump combiner). In example 400, at the interface between the oscillator fiber and the pump combiner (e.g., where the horizontal axis represents the length of the oscillator fiber, or distance from the interface between the oscillator fiber and the pump combiner), pump light at a wavelength of 976 nanometers is quickly converted to signal light at a wavelength of 1080 nanometers, resulting in a sharp increase in the power of the signal light near the interface with the pump combiner (e.g., over the first five meters). Accordingly, as shown by example 410, a heat load in the oscillator with low skew light sharply increases in the region near the interface with the pump combiner (e.g., reaching about 260 watts per meter within one or two meters from the interface with the pump combiner) due to the rapid absorption of the pump light, and the increased heat load may increase transverse mode instability (TMI) due to thermal gradients.

In contrast, FIG. 4 illustrates an example 420 of power through an oscillator coupled to a high skew pump combiner, such as a high skew pump combiner fabricated according to process 200, the high skew pump combiner 300 shown in FIG. 3, and/or the high skew pump combiner 320 shown in FIG. 3. As shown by example 420, delivering pump light that is uniformly skew or mostly skew to the oscillator and then gradually scrambling the skew light over a length of the oscillator fiber results in the signal power increasing more gradually. For example, scrambling the (initially skew) pump light over a longer distance results in the signal power in the optical fiber reaching a maximum level over a distance of at least one meter (e.g., around 15-20 meters in example 420). In addition, as shown by example 430, a heat load is distributed over a long distance of the optical fiber, and avoids the sharp initial peak. For example, scrambling the (initially skew) pump light over a longer distance results in the heat load being distributed over a distance of at least one meter (e.g., around 20 meters in example 430). Furthermore, delivering uniformly or mostly skew light to the oscillator fiber and scrambling the skew light over a length of the oscillator fiber significantly reduces the maximum heat load (e.g., peaking around 260 watts per meter in example 410 where the pump light has low skew, and peaking around 85 watts per meter in example 430 where the pump light is uniformly or mostly skew when delivered from the pump combiner to the oscillator fiber.

As indicated above, FIG. 4 is provided as an example. Other examples may differ from what is described with regard to FIG. 4. For example, relative to a pump combiner that generates all or primarily meridional light, the high skew pump combiner may provide or enable improvements to performance metrics other than distributing a heat load and/or decreasing a rate at which signal power increases in a fiber coupled to the high skew pump combiner.

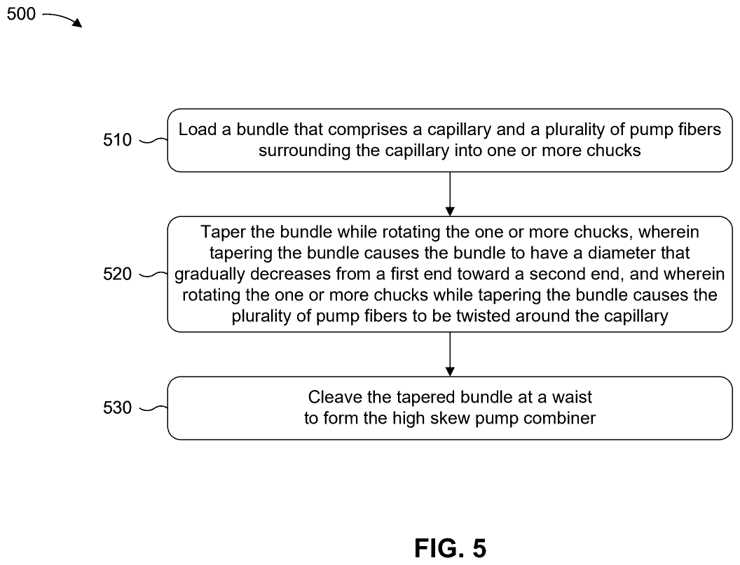

FIG. 5 illustrates an example process 500 for fabricating a high skew pump combiner. One or more process blocks of FIG. 5 are performed by optical fiber manufacturing equipment, such as equipment at an acid strip station, a flame station, or the like.

As shown in FIG. 5, process 500 includes loading a bundle that comprises a capillary and a plurality of pump fibers surrounding the capillary into one or more chucks (block 510). For example, the thing may load a bundle that comprises a capillary and a plurality of pump fibers surrounding the capillary into one or more chucks, as described above.

As further shown in FIG. 5, process 500 includes tapering the bundle while rotating the one or more chucks, wherein tapering the bundle causes the bundle to have a diameter that gradually decreases from a first end toward a second end, and wherein rotating the one or more chucks while tapering the bundle causes the plurality of pump fibers to be twisted around the capillary (block 520). For example, the thing may taper the bundle while rotating the one or more chucks, wherein tapering the bundle causes the bundle to have a diameter that gradually decreases from a first end toward a second end, and wherein rotating the one or more chucks while tapering the bundle causes the plurality of pump fibers to be twisted around the capillary, as described above.

As further shown in FIG. 5, process 500 includes cleaving the tapered bundle at a waist to form the high skew pump combiner (block 530). For example, the thing may cleave the tapered bundle at a waist to form the high skew pump combiner, as described above.

Process 500 may include additional aspects, such as any single aspect or any combination of aspects described below and/or in connection with one or more other processes described elsewhere herein.

In a first aspect, the bundle further comprises an outer capillary surrounding the plurality of pump fibers.

In a second aspect, alone or in combination with the first aspect, the plurality of pump fibers are twisted around the capillary with a rotation of approximately 360 degrees over a length of three millimeters to ten millimeters.

In a third aspect, alone or in combination with one or more of the first and second aspects, the high skew pump combiner has a length in a range from ten millimeters to forty millimeters.

In a fourth aspect, alone or in combination with one or more of the first through third aspects, the plurality of pump fibers are tapered such that a ratio of the diameter at the first end to the second end is in a range from 2:1 to 5:1.

In a fifth aspect, alone or in combination with one or more of the first through fourth aspects, the pump combiner has an input end that may be coupled to a plurality of pump diodes, and may be configured to receive pump light generated by the plurality of pump diodes and to combine the pump light into uniformly skew light, or light that is at least ninety percent skew and less than ten percent non-skew, toward the output from the pump combiner

In a sixth aspect, alone or in combination with one or more of the first through fifth aspects, the pump combiner may be included in an optical assembly that includes a laser source configured to generate signal light, a plurality of diodes configured to generate pump light, and an optical fiber coupled to the laser source and to the output end of the pump combiner such that the signal light is delivered to a core of the optical fiber and the pump light is delivered only to a cladding of the optical fiber, or such that at least ninety percent of the pump light is delivered to the cladding is skew and less than ten percent of the pump light is non-skew.

In a seventh aspect, alone or in combination with one or more of the first through sixth aspects, none of the pump light is delivered to the core at an interface between the optical fiber and the pump combiner, and wherein an amount of the pump light in the core at an output from the optical fiber is based on a total amount of the pump light, an area of the core, and an area of the cladding.

In an eighth aspect, alone or in combination with one or more of the first through seventh aspects, the pump light is scrambled over a length of the optical fiber such that the pump light gradually enters the core of the optical fiber.

In a ninth aspect, alone or in combination with one or more of the first through eighth aspects, a heat load in the optical fiber is distributed over a distance of at least one meter.

In a tenth aspect, alone or in combination with one or more of the first through eighth aspects, a signal power in the optical fiber reaches a maximum level over a distance of at least one meter.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A pump combiner, comprising:
a central capillary; and
a plurality of pump fibers surrounding the central capillary, wherein the plurality of pump fibers are twisted around the central capillary and tapered toward an output from the pump combiner.

2. The pump combiner of claim 1, wherein the plurality of pump fibers are configured to receive pump light generated by a plurality of pump diodes and to combine the pump light into uniformly skew light toward the output from the pump combiner.

3. The pump combiner of claim 1, wherein the plurality of pump fibers are configured to receive pump light generated by a plurality of pump diodes and to combine the pump light into at least ninety percent skew light and less than ten percent non-skew light.

4. The pump combiner of claim 1, wherein the plurality of pump fibers are twisted with a rotation of approximately 360 degrees over a length of three millimeters to ten millimeters.

5. The pump combiner of claim 1, wherein the pump combiner has a length in a range from ten millimeters to forty millimeters.

6. The pump combiner of claim 1, wherein the plurality of pump fibers are tapered such that a ratio of a first area at an input to the pump combiner to a second area at the output from the pump combiner is in a range from 2:1 to 5:1.

7. The pump combiner of claim 1, further comprising:
an outer capillary, surrounding the plurality of pump fibers.

8. A method for fabricating a high skew pump combiner, comprising:
loading a bundle that comprises a capillary and a plurality of pump fibers surrounding the capillary into one or more chucks;
tapering the bundle while rotating the one or more chucks, wherein tapering the bundle causes the bundle to have a diameter that gradually decreases from a first end toward a second end, and wherein rotating the one or more chucks while tapering the bundle causes the plurality of pump fibers to be twisted around the capillary; and
cleaving the tapered bundle at a waist to form the high skew pump combiner.

9. The method of claim 8, wherein the bundle further comprises an outer capillary surrounding the plurality of pump fibers.

10. The method of claim 8, wherein the plurality of pump fibers are twisted around the capillary with a rotation of approximately 360 degrees over a length of three millimeters to ten millimeters.

11. The method of claim 8, wherein the high skew pump combiner has a length in a range from ten millimeters to forty millimeters.

12. The method of claim 8, wherein the plurality of pump fibers are tapered such that a ratio of the diameter at the first end to the second end is in a range from 2:1 to 5:1.

13. An optical assembly, comprising:
a laser source configured to generate signal light;
a plurality of diodes configured to generate pump light;
a pump combiner that comprises a central capillary and a plurality of pump fibers surrounding the central capillary, wherein the plurality of pump fibers are coupled to the plurality of diodes at an input end of the pump combiner, and wherein the plurality of pump fibers are twisted around the central capillary and tapered toward an output end of the pump combiner; and
an optical fiber coupled to the laser source and to the output end of the pump combiner such that the signal light is delivered to a core of the optical fiber and the pump light is delivered only to a cladding of the optical fiber.

14. The optical assembly of claim 13, wherein none of the pump light is delivered to the core at an interface between the optical fiber and the pump combiner, and wherein an amount of the pump light in the core at an output from the optical fiber is based on a total amount of the pump light, an area of the core, and an area of the cladding.

15. The optical assembly of claim 13, wherein the pump light is scrambled over a length of the optical fiber such that the pump light gradually enters the core of the optical fiber.

16. The optical assembly of claim 13, wherein a heat load in the optical fiber is distributed over a distance of at least one meter.

17. The optical assembly of claim 13, wherein a signal power in the optical fiber reaches a maximum level over a distance of at least one meter.

18. The optical assembly of claim 13, wherein the plurality of pump fibers are twisted around the central capillary with a rotation of approximately 360 degrees.

19. The optical assembly of claim 13, wherein the plurality of pump fibers are tapered such that a ratio of a first area of the pump combiner at a first interface with the plurality of pump diodes to a second area of the pump combiner at a second interface with the optical fiber is in a range from 2:1 to 5:1.

20. The optical assembly of claim 13, wherein the pump combiner further comprises an outer capillary, surrounding the plurality of pump fibers.
